(19) United States
(12) Patent Application Publication
(10) Pub. No.: US 2021/0198000 A1
(43) Pub. Date: Jul. 1, 2021

(54) Three-dimensional Gift Box with Acousto-optic Effect

(71) Applicant: Shenzhen Winpsheng Creative Greeting Card Company Limited, Shenzhen (CN)

(72) Inventor: Jingyun Sun, Shenzhen (CN)

(21) Appl. No.: 16/847,660

(22) Filed: Apr. 14, 2020

(30) Foreign Application Priority Data
Dec. 31, 2019 (CN) 201922472554.2

(51) Int. Cl. B65D 5/42; B65D 51/24; B65D 25/02

(52) U.S. Cl. CPC B65D 5/4258; B65D 51/248; B65D 2203/12; B65D 25/02; B65D 5/422

(57) ABSTRACT

A three-dimensional gift box with acousto-optic effect includes a box body and a box lid; a first partition board and a second partition board which are provided in the box body, the first partition board is fixedly fitted to the inner edge of the box body, the second partition board is detachably fitted to the inner edge of the box bod; a circuit layer, which is formed in the space between the first partition board and the bottom plate of the box body; a storage layer, which is formed in the space between the first partition board and the second partition board; a foldable pop-up card, which is arranged between the second partition board and the inner side of the box lid; an electronic assembly module for producing the acousto-optic effect, which is arranged in the circuit layer.

### CROSS REFERENCE TO RELATED APPLICATIONS

The present application claims the benefit of Chinese Patent Application No. 201922472554.2 filed on Dec. 31, 2019, the contents of which are incorporated herein by reference in their entirety.

### TECHNICAL FIELD

The present disclosure relates to gift boxes, and particularly to a three-dimensional gift box with acousto-optic effect.

### BACKGROUND

When people present gifts in various social occasions, the additional effect of an exquisite and unique gift box which upgrading the grade of the present in the gift box cannot be ignored. Nowadays, the conventional gift box on the market are basically a container with certain shape and interior which showing slightly monotonous expression and is unable to meet the increasingly demand from the customers.

### SUMMARY

In order to overcome the shortcomings of the prior art, the present disclosure provides a three-dimensional gift box with acousto-optic effect, which have both of the functions of a pop-up card and acousto-optic effect, and thus solves the problem of monotonous expression of the traditional gift box.

A three-dimensional gift box with acousto-optic effect includes:
a box body and a box lid;
a first partition board and a second partition board which are provided in the box body, the first partition board is fixedly fitted to the inner edge of the box body, the second partition board is detachably fitted to the inner edge of the box body;
a circuit layer, which is formed in the space between the first partition board and the bottom plate of the box body;
a storage layer, which is formed in the space between the first partition board and the second partition board;
a foldable pop-up card, which is arranged between the second partition board and the inner side of the box lid, the upper part of the pop-up card is connected with the inner side of the box lid and the lower part of the pop-up card is connected with the second partition board; and
an electronic assembly module for producing the acousto-optic effect, which is arranged in the circuit layer.

Alternatively, the electronic assembly module comprises a PCBA board, on which a horn, a LED light and a trigger switch for detecting the opening and closing status of the box lid are provided.

Alternatively, the trigger switch comprises at least one of the Microphone, the photoelectric sensor, the gravity sensor, the remote sensing sensor, the hall switch and the magnetron tube.

Alternatively, the range of the expansion angle of the pop-up card is from 90 degrees to 180 degrees.

Alternatively, the shape of the box body is either a regular geometrical shape or an irregular geometrical shape.

Alternatively, an upper supporting board is arranged between the upper part of the pop-up card and the inner side of the box lid, and a lower supporting board is arranged between the lower part of the pop-up card and the second partition board.

Alternatively, the upper part of the pop-up card is either fixedly fitted or detachably fitted to the upper supporting board; the lower part of the pop-up card is either fixedly fitted or detachably fitted to the lower supporting board.

Alternatively, the pop-up card is a printed pop-up card or a laser pop-up card.

Alternatively, the base material used for the box body and box lid is any one of wood, cardboard and plastic.

Alternatively, the surface material used for the box body and box lid is any one of paper, leather, fabric and plastic film.

The present disclosure provides a three-dimensional gift box with acousto-optic effect, wherein the space in the box body is divided into three regions, in which, the circuit layer between the first partition board and the bottom plate of the box body comprises an electronic assembly module with a sound and light emitting function; the storage layer between the first partition board and the second partition board is used for containing gifts; and the foldable pop-up card is provided in the space between the second partition board and the inner side of the box lid, the upper and lower parts of the pop-up card are connected with the inner side of the box lid and the second partition board respectively. When the box lid is opened, the pop-up card can be shown with the greeting function; When the second partition board is opened, the gift contained in the storage layer can be seen and taken out; When either the box lid or the second partition board is opened, the electronic assembly module can be triggered to work, and produces the corresponding music and/or light effect according to the pre-set program which providing multiple experiences such as visual, acoustic, optical and electric experiences for the user, and the present disclosure thus solves the problem of single monotonous monotony expression of the traditional gift box.

### BRIEF DESCRIPTION OF THE DRAWINGS

FIG. 1 is an expansion view of an embodiment when the three-dimensional gift box with acousto-optic effect is opened (180 degrees), according to the present disclosure;

FIG. 2 is a structure section diagram of an embodiment of the three-dimensional gift box with acousto-optic effect, according to the present disclosure;

FIG. 3 is a structure decomposition diagram of an embodiment of the three-dimensional gift box with acousto-optic effect, according to the present disclosure;

FIG. 4 is an expansion view of another embodiment when the three-dimensional gift box with acousto-optic effect is opened (90 degrees), according to the present disclosure;

FIG. 5 is a structure section diagram of another embodiment of the three-dimensional gift box with acousto-optic effect, according to the present disclosure;

FIG. 6 is a structure decomposition diagram of another embodiment of the three-dimensional gift box with acousto-optic effect, according to the present disclosure.

The reference characters which denote corresponding features in the drawings are marked as follows:

1. box body; 2. box lid; 3. pop-up card; 4. first partition board; 5. second partition board; 6. storage layer; 7. circuit layer; 8. PCBA board; 9. upper supporting board; 10. lower supporting board.

### DETAILED DESCRIPTION OF THE EMBODIMENTS

The above is only a summary of the technical solutions of the present disclosure. For a clear understanding of the technical problem to be solved in the present disclosure and the technical means and effect of the present disclosure, the present disclosure is further described in detail below with reference to the accompanying drawings and specific embodiments.

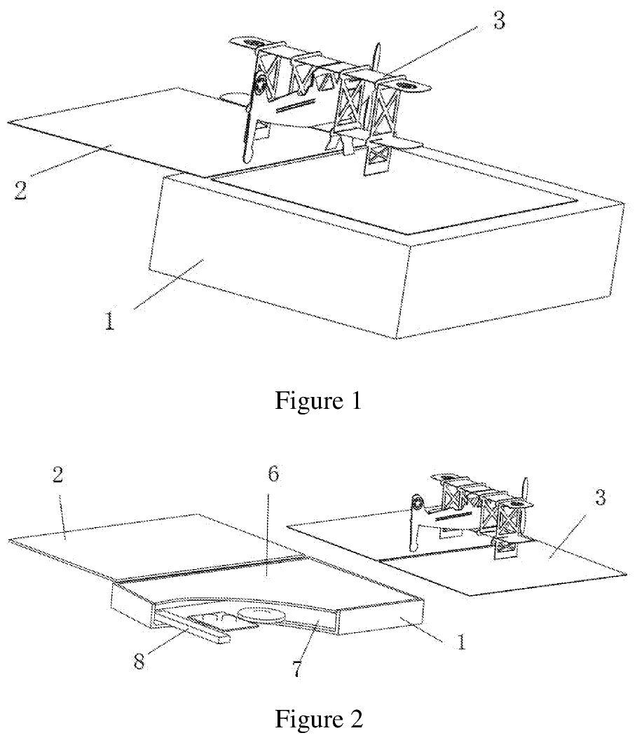

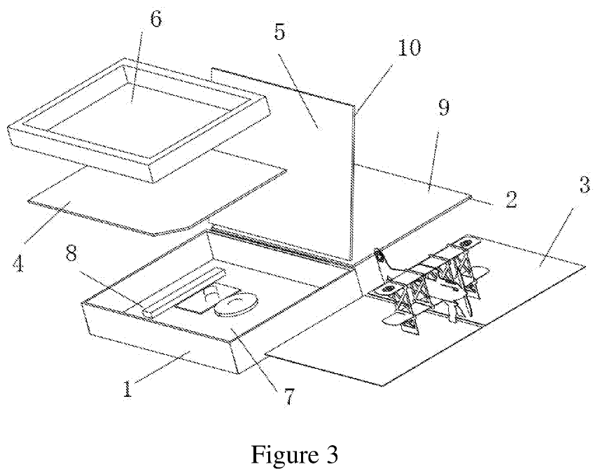

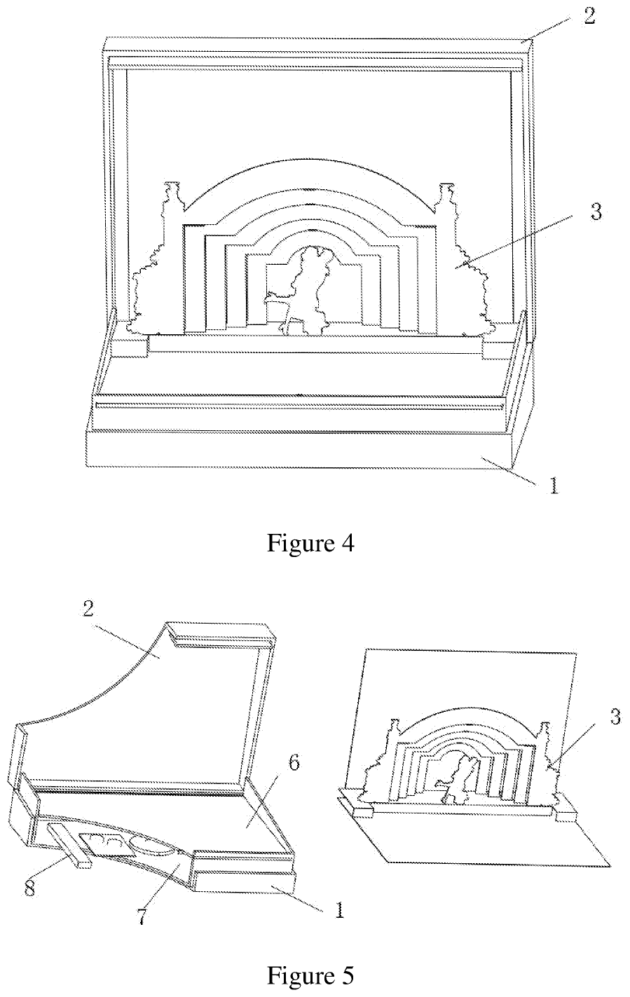

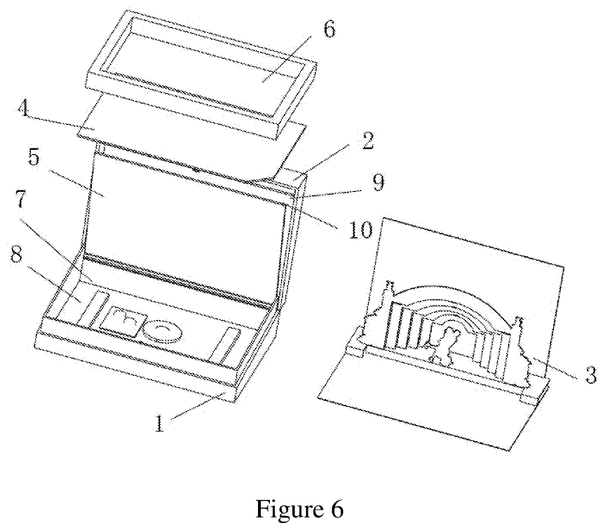

A three-dimensional gift box with acousto-optic effect, as shown in FIG. 1-FIG. 6, in which, FIG. 1 to FIG. 3 show the pop-up card with expansion of 180 degrees; FIG. 4 to FIG. 6 show the pop-up card with expansion of 90 degrees. Box body 1 is a rectangular shape, but the box body is not limited to this kind of shape, it may also be other regular geometry shapes such as round shaped or star shaped, and or other irregular geometry shapes, which is not restricted here. The box lid 2 is used to cover and close on the box body. The base material used for the box body and box lid can be any of the wood, cardboard and plastic, which is not restricted here. The surface material used for the box body and box lid can be any of the paper, leather, fabric and plastic film, which is not restricted here.

When the box lid 2 is opened, the foldable pop-up card 3 can be displayed in front of the user; The material used for pop-up card can be printed paper or laser marked paper. The topical subject expressed on the pop-up card can be character, architecture, scenery, scene, logo, equipment, container and/or jewelry, etc. The range of the pop-up card can be expanded changes from 90 to 180 degrees.

The box body is divided into two spatial regions by the first partition board 4 and the second partition board 5, which are the storage layer 6 and the circuit layer 7 respectively, where, the storage layer is used for containing gifts, greeting cards, etc., the second partition board is detachably fitted with box body, which is convenient for the user to open the second partition board and take out the items contained in the storage layer; the circuit layer is provided with a PCBA board 8, on which an electronic assembly module for producing the acousto-optic effect is arranged.

Alternatively, a upper supporting board 9 is arranged between the upper part of the pop-up card and the inner side of the box lid, and a lower supporting board 10 is arranged between the lower part of the pop-up card and the second partition board; The upper supporting board 9 is used for supporting the pop-up card; the upper part of the pop-up card is either fixedly fitted or detachably fitted to the upper supporting board, the lower part of the pop-up card is either fixedly fitted or detachably fitted to the lower supporting board, which is to say that the pop-up card can be fixedly fitted or detachably fitted to the supporting boards according to the requirement of the practical applications.

The electronic assembly module on the PCBA board, in addition to include the necessary processing IC and conventional electronic components, but also includes a horn for providing sound effect; an LED light for providing the light display effect, and a trigger switch for detecting the opening and closing status of the box lid. that is, by triggering the switch, different acousto-optic effects can be achieved. For example, if the trigger switch is Hall switch, when the user opens the box lid, the Hall switch can be triggered, and then the processing IC on the PCBA board will drive the horn according to the pre-set program to issue the pre-set or temporary input music ringtone, and the LED light will flash out different optic effects, thus the user can enjoy a full range of visual and acoustical experiences.

it needs to be explained that the specific implementation of the trigger switch is not limited to the hall switch, but also includes but is not limited to the microphone, photoelectric sensor, gravity sensor, remote sensing sensor, magnetron tube, etc. Among them, the microphone can convert a sound signal into an electrical signal, that is, through the sound to achieve the trigger; the photoelectric sensor can convert a light signal into an electrical signal, that is, through the different photosensitization by opening/closing box lid, to achieve the trigger; the gravity sensor can convert the displacement of the box body or the box lid into an electrical signal. Based on different trigger switch realization modes, multi kinds of control modes, such as optical control, magnetic control, sound control, vibration, and conventional button can be achieved for the gift box of the present disclosure, which can be applied to different application scenarios.

It should be understood that the specific embodiments described above are only used to interpret the disclosure and are not used to limit the disclosure. It should be noted that those skilled in the art can make several improvements and modifications without departing from the technical principles of the present disclosure, and these improvements and modifications should also fall within the scope of protection of the present disclosure.

1. A three-dimensional gift box with acousto-optic effect, comprising:
a box body;
a box lid;
a first partition board and a second partition board which are provided in the box body, the first partition board being fixedly fitted to an inner edge of the box body, the second partition board being detachably fitted to an inner edge of the box body;
a circuit layer, which is formed in a space between the first partition board and a bottom plate of the box body;
a storage layer, which is formed in a space between the first partition board and the second partition board;
a foldable pop-up card, which is arranged between the second partition board and an inner side of the box lid, an upper part of the pop-up card being connected with the inner side of the box lid and a lower part of the pop-up card being connected with the second partition board; and
an electronic assembly module for producing the acousto-optic effect, which is arranged in the circuit layer.

2. The three-dimensional gift box with acousto-optic effect according to claim 1, wherein, the electronic assembly module comprises a PCBA board on which a horn, an LED light and a trigger switch are provided, the trigger switch being used for detecting opening and closing status of the box lid.

3. The three-dimensional gift box with acousto-optic effect according to claim 2, wherein, the trigger switch comprises at least one of a Microphone, a photoelectric sensor, a gravity sensor, a remote sensing sensor, a hall switch and a magnetron tube.

4. The three-dimensional gift box with acousto-optic effect according to claim 1, wherein, a range of an expansion angle of the pop-up card is from 90 degrees to 180 degrees.

5. The three-dimensional gift box with acousto-optic effect according to claim 1, wherein, a shape of the box body is either a regular geometrical shape or an irregular geometrical shape.

6. The three-dimensional gift box with acousto-optic effect according to claim 1, wherein, an upper supporting board is arranged between the upper part of the pop-up card and the inner side of the box lid, and a lower supporting board is arranged between the lower part of the pop-up card and the second partition board.

7. The three-dimensional gift box with acousto-optic effect according to claim 6, wherein, the upper part of the pop-up card is either fixedly fitted or detachably fitted to the upper supporting board; the lower part of the pop-up card is either fixedly fitted or detachably fitted to the lower supporting board.

8. The three-dimensional gift box with acousto-optic effect according to claim 1, wherein, the pop-up card is a printed pop-up card or a laser marked pop-up card.

9. The three-dimensional gift box with acousto-optic effect according to claim 1, wherein, a base material used for the box body and the box lid is any one of wood, cardboard and plastic.

10. The three-dimensional gift box with acousto-optic effect according to claim 1, wherein, a surface material used for the box body and the box lid is any one of paper, leather, fabric and plastic film.
